(19) United States
(12) Patent Application Publication
(10) Pub. No.: US 2019/0347946 A1
(43) Pub. Date: Nov. 14, 2019

(54) SIMULATED AUGMENTED CONTENT

(71) Applicant: Hewlett-Packard Development Company, L.P., Spring, TX (US)

(72) Inventors: Ricardo Beck, Porto Alegre (BR); Diego Gimenez Pedroso, Porto Alegre (BR); Carine Roza, Porto Alegre (BR)

(21) Appl. No.: 16/461,502

(22) PCT Filed: Jan. 17, 2017
(86) PCT No.: PCT/US2017/013800

§ 371 Date: May 16, 2019

(51) Int. Cl. G09B 5/02; G09G 5/37; G06F 9/451; G06F 16/953

(52) U.S. Cl. CPC G09B 5/02; G09G 5/37; G09G 2354/00; G06F 16/953; G09G 2340/0492; G06F 9/451

(57) ABSTRACT

In one example, a device to display simulated augmented content is described. A computer readable medium includes instructions and a list containing a set of indexes. A processor executes the instructions to receive on the device visual data providing multiple images of a set of unique identifiers on a page of learning material associated with a page index. A set of unique identifier indexes and a set of orientation data for each unique identifier is created. A set of content for the page of learning material is identified. Simulated augmented content using the set of content is generated for display on the device. The orientation of the simulated augmented content is based on the set of content and at least one of the set of orientation data and the set of unique identifiers.

### BACKGROUND

Even before the first printing presses, people have used books and other learning materials to spread a wealth of information and ideas. However, new information and ideas are continually being generated and printed content may become obsolete and may also tend to misinform readers. Digital communication has allowed for several new and different ways of publishing learning content that allows for updating content. Nevertheless, the rate of knowledge growth is rapidly increasing given the advancement of the Internet throughout the world. Consequently, even digital books that are created on demand are often out-of-date within a few months of their release.

Furthermore, the advancement of social media, video games, computer generated images, and three-dimensional (3D) movie technology have created an expectation among readers for rich experiences such that many static printed and digital books, e.g. dull and mind-numbing textbooks, cannot compete for a reader's attention.

### BRIEF DESCRIPTION OF THE DRAWINGS

The disclosure is better understood with reference to the following drawings. The elements of the drawings are not necessarily to scale relative to each other. Rather, emphasis has instead been placed upon clearly illustrating the claimed subject matter. Furthermore, like reference numerals designate corresponding similar, though perhaps not identical, components through the several views. For the sake of brevity, reference numerals or features having a previously described function may or may not be described in connection with other drawings in which they appear.

FIG. 1 is an illustration of an example environment for creating and sharing simulated augmented content;

FIG. 2 is an illustration of another example environment for creating and sharing simulated augmented content;

FIG. 3 is an illustration of an example book and example device for viewing simulated augmented content with the example book;

FIG. 4 is an illustration of the use of the example book and example device of FIG. 3 showing various simulated augmented content;

FIG. 5 is an illustration of an alternative example device used with the example book of FIG. 3 to view simulated augmented content;

FIG. 6 is a block diagram of an example device to view simulated augmented content;

FIG. 7 is a block diagram of an alternative example device to view simulated augmented content;

FIGS. 8A and 8B are block diagrams of example instructions to allow viewing of simulated augmented content on various example devices;

FIG. 9A is a block diagram of an example system for creating books with simulated augmented content; and

FIG. 9B is a block diagram of possible additional instructions for the example system of FIG. 9A.

### DETAILED DESCRIPTION

Constantly updating printed books to keep their information content updated to reflect current technology and ideas may use numerous natural resources. This resource consumption leaves an unwelcome footprint in the Earth's ecosystem. Digital books may be created that help lessen the size of this footprint but the content of most digital books is still static like printed books and may not allow a reader or learner, such as students, scholars, pupils, apprentices, novices, etc., to advance in their studies outside of a particular learning experience taught in the digital book. Further, some learners particularly enjoy and may learn better with physical books as they allow for quick access, highlighting, scribbling comments, and tabbing of the various content. Thus, these learners tend to avoid digital books because they provide little additional learning advantage for them other than perhaps cost, size and weight.

Accordingly, the example implementations disclosed herein provide a rich ecosystem for the creation of books, such as textbooks and other learning material by an instructor that allows for both printed and digital learning content to be updated and augmented with a rich array of various simulated augmented reality (AR) media that allows an instructor to immerse groups of one or more learners into a virtual environment with simulated augmented content. The simulated augmented content allows for multiple AR content per page of material, targeted AR material for individual learners, social sharing of notes, communication, and additional AR content within learner groups and the instructor. Moreover, the instructor may create multiple flows of different AR content and can continually update the additional AR content.

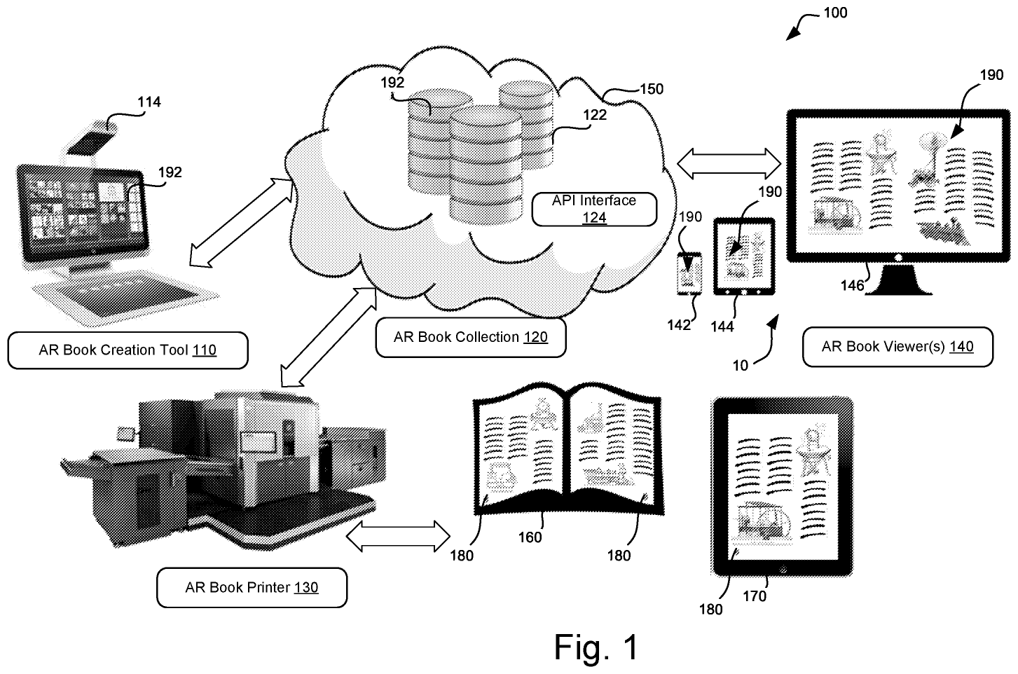

For instance, FIG. 1 is an illustration of an example environment 100 for creating and sharing simulated augmented content 190. Instructors, such as teachers, professors, educators, tutors, coachers, and trainers, etc. may select customizable content 192 uploaded and stored on a database 122 on one or more AR book collections 120 for specific pages, chapters, pictures, and the like using an augmented reality (AR) book creation tool 110. Database 122 may be a relational or structured database such as Oracle™ SQL server™, MySQL™, DB2™, Postgres™, and similar. However, other SQL and noSQL databases such as Vertica™, MongoDB™, Cassandra™ Neorj™, etc. known to those of skill in the art may be used as well. In some examples, more than one database may be used.

The AR book creation tool 110 allows instructors to setup and create a customized book such as physical book 160 using AR book printer 130. The AR book creation tool 110 may also create a digital book 170 which may be an electronic copy of physical book 160 or an augmented electronic copy of physical book 160. The physical book 160 and the digital book 170 may be one or more of a type of textbook, primer, reference, manuscript, and the like. Scanner 114 may be used to scan physical books and other material, including 3D objects, into electronic format. In one example, the AR book creation tool 110 is an application running on a Hewlett-Packard™ Sprout™ PC with a projector that helps with lighting and aligning use with a 2D page scanner, a 3D scanner, and/or an HP 3D capture stage. In another example, the AR book creation tool 110 is a personal computer, server, notebook, tablet, or smartphone, etc. coupled to a 2D scanner and/or a 3D scanner such as a ‘3D Scanner iSense™’, a ‘David SLS-2 3D™’ scanner, an ‘XYZprinting DaVinci™’ scanner and printer, and the like. The content of the customized book pages and the customizable content 192 may be stored on a cloud-based or other type of database 122 in one or more cloud systems 150 implementing AR book collection 120. Cloud system 150 may be implemented with private, public, or shared remote or local servers hosted on a network typically connected to the Internet. The cloud system 150 allows for the storage, management, and processing of an AR book via an AR book collection 120 containing simulated augmented content 190 on database 122 built-up from the customized book pages and the customizable content 192 using one or more application programming interfaces (APIs) 124.

The selection of pages, chapters, pictures, etc. from customizable content 192 may be used with the AR book creation tool 110 to modify the textual content as well as to associate one or more rich media elements such as 3D content, 3D objects, enhanced images, movies, or interactive media with various pages, chapters, and/or images before ordering a print of a physical book 160 or digital book 170 for a specific group of learners at AR book printer 130. In some implementations, a physical book 160 may not be desired or in addition to a physical book a digital book 170 may be created by AR book creation tool 110 using several different computer-based digital publishing solutions such as Adobe Acrobat™, Amazon Kindle™ books, Lulu™, etc. in one or more proprietary or open-source formats such as portable document format (PDF) and others known to those of skill in the art.

AR book printer 130 may be a Hewlett-Packard™ Indigo Digital Press™, a Hewlett-Packard™ Web Press™, or other physical book printing solution known to those of skill in the art. The AR book printer 130 may be connected to the database 122 or in some implementations may be able to receive a final book electronic file from the instructor indirectly such as with various forms of transportable media, e.g. hard drives, flash cards, USB drives, optical discs, and the like. After printing, the instructor may manage the associated augmented content to the book stored in database 122 by using the AR book creation tool 110 to modify or update the book's content and/or adding more content to different areas of the book.

Learners may use one or more electronic devices 10 as an AR book viewer 140, such as a smartphone 142, a tablet 144, or a personal computer 146. The smartphone 142 may also encompass personal data assistants, e-book readers, phablets, etc. The tablet 144 may also encompass small and larger e-book readers, 2-in-1, 3-in-1, or other tablet configurable notebook computers. The personal computer 146 may also encompass, laptops, notebooks, Chromebooks, netbooks, desktops, all-in-ones, servers, and the like. The AR book viewers 140 operating on an electronic device 10 may control one or more cameras for viewing and identifying multiple content markers on the physical book 160. When a digital book 170 is used, the augmented contents of the book may be viewed on a display screen of the particular electronic device 10. For some learners, they may use one or more of the various types of electronic devices 10 with AR book viewers 140 separately or together to view the enhanced simulated augmented content 190 of the created book.

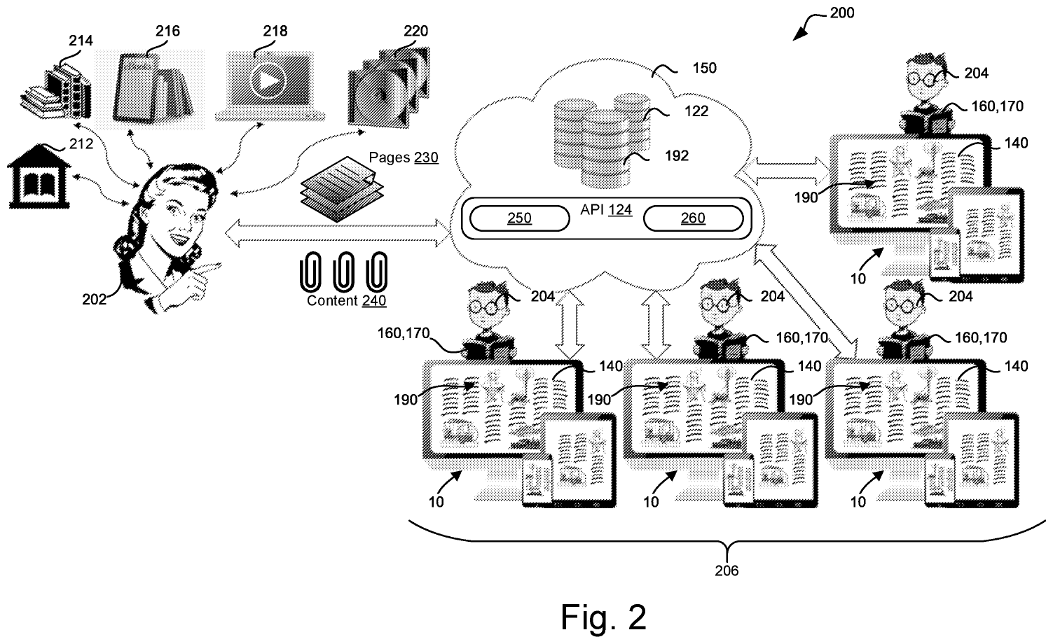

FIG. 2 is an illustration of another example environment 200 for creating and sharing simulated augmented content 190. For instance, an instructor 202 may select from one or more available media materials to create the customizable content 192 used to create a book 160, 170 for a particular learning lesson with a group of learners 206 having one or more learners 204. The available media materials may come from a physical or on-line library 212, a set of personal or department references 214, electronic books 216, computer media 218 and multi-media 220. Any physical material from library 212 and references 214 may be scanned into a portable document (PDF), ePub, AZW, MOBI, or other e-book electronic format such as used with the electronic books 216. The computer media 218 and multi-media 220 may be one or more various media formats such as JPEG, PNG, MOV, AVI, ASF, QT, AVCHD, FLV, SWF, MP3, MP4, etc. Accordingly, creation of a customizable book by instructor 202 can take advantage of existing protocols, formats, and solutions for creating digital books.

Nevertheless, with the AR book creation tool 110, an instructor 202 can create a far more enriched and encompassing learning experience than typical digital book publishing. AR book creation tool 110 allows the instructor 202 to select pages, chapters, and pictures from the library 212, references 214, electronic books 216, computer media 218 and multi-media 220 in the e-book and media formats. When an item is selected, an exclusive watermark, markers, or other unique identifier 180 is associated with the item and together they are stored in database 122 within cloud 150. By associating items such as page content and media on the page with unique identifies 180, the various items may be identified later by their respective unique identifiers 180. Alternatively, the unique identifier 180 may be generated by examining the media item and creating a unique electronic tag based off physical properties or attributes of the media, such as weighted moments of various color vectors of a photo, edge matching, greyscale matching, gradient matching, histograms, eigenvectors, scale invariant feature transforms, and the like. Other photo and media identification techniques are known to those of skill in the art.

Database 122 may include one or more application program interfaces (API) 124 organized in a set of communication routines or protocols to interface with AR book creation tool 110, AR book viewer 140, and perhaps AR book printer 130. Various web-based API architectures may be used and may include one or more Internet application layer protocols hypertext transfer protocol (HTTP) or Secure HTTP (HTTPS) request messages formatted in extensible markup language (XML) or JavaScript™ object notation (JSON) formats. Different protocols may be used such as simple object access protocol (SOAP), service oriented architecture (SOA), representational state transfer (REST) and resource-oriented architecture (ROA) as well as others known to those of skill in the art. The API 124 may support different types of electronic devices 10 as well as multiple mobile operating systems on electronic devices 10 including iOS™, Android™ webOS™, Windows 10 Mobile™, various revisions of Windows™, Linux™ Unix™, and MacOS™, and other operating systems known by those of skill in the art.

Electronic devices 10 may communicate with API 124 using one or more communication protocols including the Internet protocols IPv4 and IPv6, and transport layer protocols such as Transmission Control Protocol (TCP), User Datagram Protocol (UDP) or others known to those of skill in the art. Wired or optical network protocols for intranets and extranets may include IEEE 802.3, 10-Base-T, 100-Base-TX, and 1000-Base-T using various standard and non-standard physical connectors over twisted pair, coaxial cable, and optical cable. Other Ethernet protocols are known to those of skill in the art. Further, several different wireless protocols such as various IEEE 802.11 protocols (e.g. 802.11a, 802.11b, 802.11g, 802.11n, 802.11ac, etc.), Bluetooth basic rate/enhanced data rate (BR/EDR) versions 2.0/2.1 and Bluetooth with low energy (LE) versions 4.0/4.1/4.2, Bluetooth version 5. Other wireless or optical protocols can also be used such as near field communications (NFC) such as Ecma-340 and ISO/IEC 18092 for NFC and IrDA IrPHY 1.3 as just some examples.

In some implementations, there may be an instructor API 250 and a learner API 260 or they may be combined within a single API 124. Additional APIs may also be included to provide additional functions. An instructor API 250 may allow instructors 202 to login, upload files, associate various content, such as pages and pictures, to AR content, and selection of different flows for specific content. The instructor API 250 may also allow the instructor 202 to manage different groups of learners 204 in learner group 206 such as for different classes, programs, or curricula. The learner API 260 may allow learners 204 to login, save progress, and select content based on their respective instructor's rules.

An instructor 202 may select one or more books or other learning materials for the class from the library 212, references 214, and e-books 216. Then the instructor 202 may upload electronic formats of the various desired pages 230 (such as in PDF or other electronic document formats) and/or attachable AR media content 240 to the database 122 via the instructor API 250 to create the customizable content 192 in the database 122. The instructor 202 may then associate the just uploaded customizable content 192 with a unique identifier 180 as desired using the AR book creation tool 110. The instructor 202 may also associate particular learners 204 or groups of learners with the AR book content, which is a collection of the customizable content 192 stored on database 122. The AR book content then may be marked as “ready” by the instructor 202 to be used, printed, or distributed to associated learners in print or digital format.

Accordingly, a learner 204 may retrieve either a physical book 160 or an e-book 170. AR book viewer 140 may be an application that can be downloadable onto the learner's electronic device 10 and run as an application. Alternatively, the AR book viewer 140 may be a standalone electronic device 10 dedicated to running the AR book viewer 140 software to minimize distractions from emails, text messages, social messaging, and the like. The learner 204 may open or otherwise run the AR book viewer 140 application. A learner 204 may login to the learner API 260 from the AR book viewer 140. In some implementations, the learner 204 may select or be assigned to an assigned group of learners 206, create a unique group of learners 206, or join an existing group of learners 206. Following the instructions on the screen in the AR book viewer 140 app, the learner 204 opens a physical book 160 or digital book 170 and points the AR book viewer 140 device's camera at the open page. Various AR content associated with the particular page, identified by one or more unique identifiers 180 (such as by a unique marker or by image recognition), brings up simulated augmented content 190 on the display of electronic device 10 and the learner 204 may then interact with it.

The unique identifier 180 is preferably unnoticeable to a human eye but recognizable by AR book viewers 140. For instance, each page may be marked with an exclusive unique watermark by pressing the paper of the page in a mold or using a programmable deformable roll during the book manufacturing process in AR book printer 130 for a physical book 160. In other examples, the watermark may be done by using a special ink that is relatively invisible to a human eye but of a frequency or distribution that can be read by a camera on the AR book viewer 140. In other examples, the printing of the watermark on each page may be done by using visible ink, but done in a way that distributes the ink in a manner that is not unpleasing to the human eye but recognizable by the camera with appropriate software on the AR book viewer 140. The unique identifiers 180 for the media may similar watermarks or may include merging one or more patterns into an image to allow for quick identification by the camera on AR book viewer 140. In some implementations, the media or page content may be recognized by one or more vector-based identification systems, such as moment weighted systems or other image recognition systems noted earlier. In general, the unique identifier 180 is marker that is covertly embedded or covertly represented by the physical characteristics of the page or media and recognizable by the camera of electronic device 10. Accordingly, the unique identifier 180 once entered into the database 122 becomes ‘a tracker-ID’ for individual content pages and each AR media object associated with a content page. Accordingly, there may be multiple markers (unique identifiers 180) per page. Further, each unique identifier may also include location information of the identifier and/or its content with respect to the page in which it is associated.

Furthermore, each page or media content entered into the database 122 includes or is associated with an instructor ID used to track ownership of the page and AR content. Accordingly, each physical book 160 or digital book 170 may have different AR content based on the instructor ID and thus instructors 202 may work together or separately to create or use the same original book but have different updated AR content. Additionally, in some implementations, an instructor 202 may create different flows for each page or media content and allow a learner 204 to select different paths within the different flows. For instance, a picture may be associated with a unique identifier 180 and based on an associated instructor ID, a menu may be presented to allow a learner 204 to select from one or more options, different AR content for the picture, such as one of several movies.

For instance, if the picture was a picture of a duck, a menu may appear when the learner 204 scans the picture with AR book viewer 140 and the respective unique identifier 180 identified. Several different pictures, movies, and/or 3D models of various duck species may be presented to allow the learner 204 to have an enriched learning experience. If a new species of duck is found or its status changes to endangered or removed from endangered status, the new content can be uploaded to the database 122 by the instructor 202 and be made available to the learner 204.

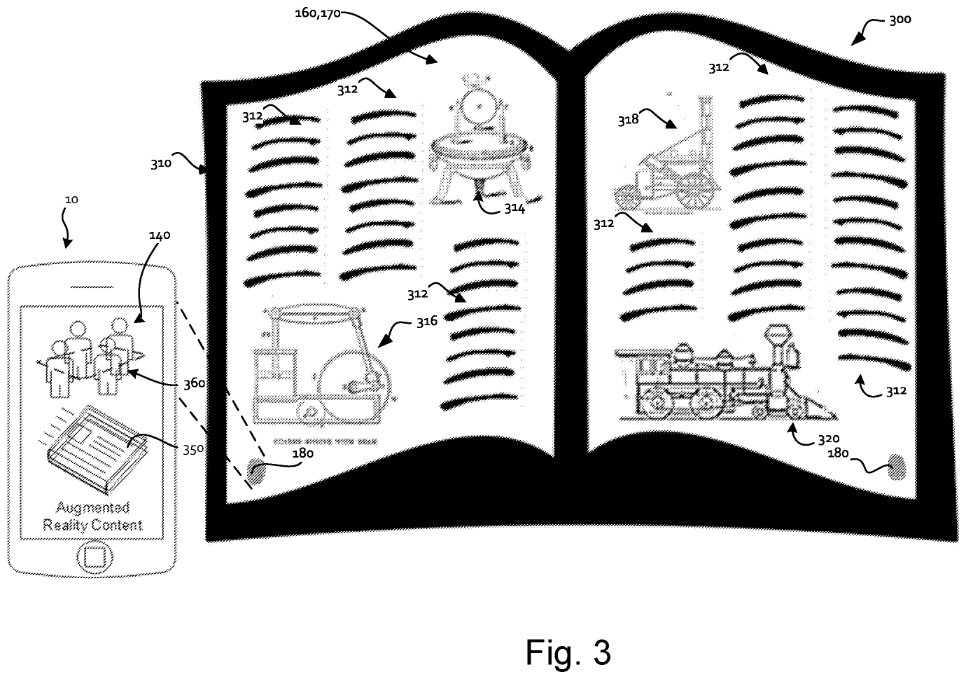

FIG. 3 is an illustration 300 of an example thermo-dynamics textbook 310 in physical book 160 or digital book 170 format exploring steam engines. Also shown is an example electronic device 10 with AR book viewer 140. In this example a smartphone is used for viewing simulated augmented content 190 with the example textbook 310. To begin, the learner 204 logs into the AR book viewer application and may select a group of learners 360 with which to jointly study. The AR book viewer 140 recognizes one or more unique identifiers 180 and allows the learner 204 to select the recognized augmented reality content 350 from an interactive menu.

For instance, the AR content selections for various flows could be a) historical, b) economic, c) thermos-dynamics theory, d) 3D models, etc. The physical book 160 or digital book 170, in this example, contains sections of textual material 312 and illustrations or pictures of various historical forms of steam engines such as Greek steam engine 314, atmospheric engine 316, early locomotive engine 318, and 19th century locomotive engine 320. Normally, the textbook 310 may have static pictures. Yet, based on technological progress and historical discovery, the information contained in the textbook 310 may be out-of-date or even lacking in “thrilling” enough material necessary to engage a learner 204, whom may be accustomed to high CGI video games with constant activity and decisional choices.

Consequently, the AR book viewer 140 provides an ability to improve the typical textbook experience by using one or more electronic devices 10 to generate and display simulated augmented content 190. Now, rather than just viewing the static pictures of the various steam engines in the textbook 310, the learner 204 may move the electronic device 10 over the pages of the textbook 310 and bring up updated or enriched content, online content, moving pictures, or an interactive 3D model that is viewable in multiple directions. This solution can be applied with older books (with image recognition for unique identifiers 180) as wells as newer printed and digital books (with image recognition or supplemental unique identifiers 180). AR book viewer 140 may create an 3D immersive experience that can provide an actual interactive experience from the book's static content. In addition, the instructor 202 can update the content presented at any moment by using the AR creation tool 110 and updating the database 122 thereby allowing near real-time updates of content material. Additional user interaction may include using the AR book viewer 140 with exercise routines, such as displaying videos or 3D models of various workouts and positions. Another user interaction scenario is using the AR book viewer 140 as an input and viewer device for video or other games.

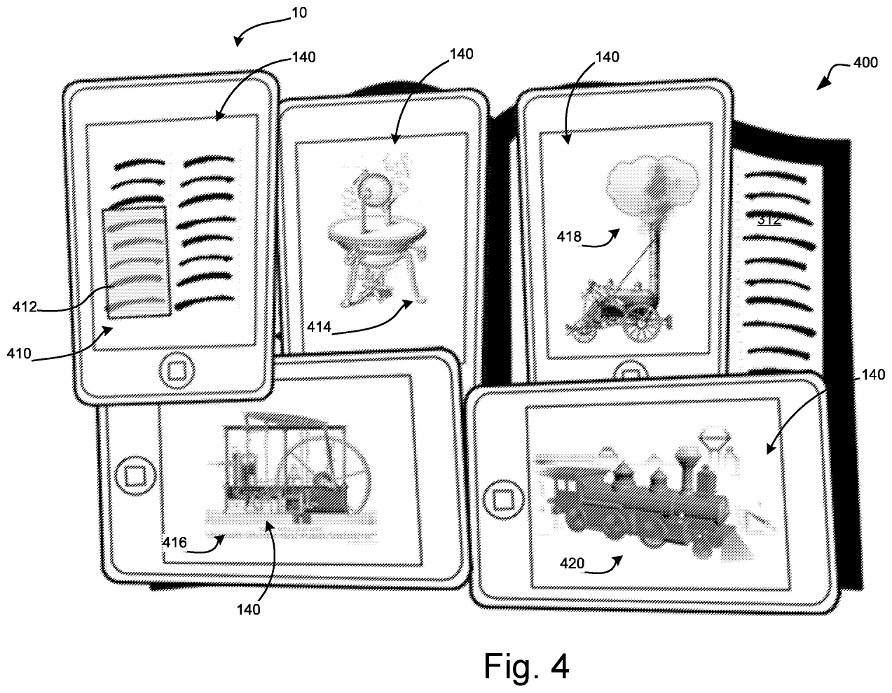

FIG. 4 is an illustration 400 of the use of the example textbook 310 and example electronic device 10 of FIG. 3 showing various simulated augmented content 190 as the AR book viewer 140 is moved across the pages of the physical book 160 or digital book 170. The AR book viewer 140 application recognizes the unique identifier 180 for each page and queries the database 122 for simulated augmented content using the unique identifier, the instructor identifier, the learner identifier, and possibly a group learner identifier and any picture identifiers. The identification of unique identifier 180 also includes position information and along with position information from the electronic device 10, as the AR book tool 110 scans across a page, any updated or enhanced content such as updated textual content 412 is shown on the display of the electronic device 10.

For instance, in first position 410, the textual material 312 may be updated or now include new weblinks (e.g. a Smithsonian Museum website on Power Machinery) and may allow a learner to select a weblink and visit the respective website to get more detailed information. In second position 414, the static picture of the Greek steam engine 314 may be replaced with an action video of the Greek steam engine 314 in actual operation by showing a fire that heats the water in the caldron and exits out of the nozzles on the ball allowing it to rotate. Additionally, by also showing the relative rotation of a valve back and forth, a learner 204 can learn that the speed of rotation of the Greek steam engine 314 may be varied depending upon the amount of steam allowed into the ball via the valve. Other weblinks may direct a learner 204 to a website describing Hero of Alexandria's historical use of steam by the Greeks, such as the auto-opening of temple doors to mystify and convince worshipers that their burnt offerings were being answered (falsely) by Greek gods.

In third position 416, the simple static picture of the atmospheric engine 316 may be updated with a more detailed version of a working historical atmospheric engine 316. Further, the learner 204 may touch the picture and may bring up a webpage to an online book or video with detailed information on the physics of operation and perhaps also the social, economic, and business ramifications of the development of the historical atmospheric engine 316. For instance, the learner 204 may learn that coal mines (or factories) no longer needed to be located near streams where water wheels were used to supply power for pumps to rid the mines of seeping water. Further, they may learn that the use of the historical atmospheric engine 316 created a market for the coal product it helped produce as the coal was used to heat the steam used to drive the engine, thereby creating both the “chicken” (the atmospheric engine) and the “egg” (increased production of coal), a unique economic development that drove rapid adoption of the technology.

In fourth position 418, the static picture of early locomotive engine 318 may be replaced with a video showing the actual operation of the engine. Again, additional information such as weblinks and other content may be accessed by the learner 204 touching the video shown on the screen. Similarly, for fifth position 420, the static picture of 19th century locomotive 320 may be replaced with a 3D model of the locomotive that can be viewed by a user from several different angles based on the orientation of the electronic device 10 relative to the example physical book 160 or digital book 170. Having the learner 204 touch the screen on the electronic device 10 may bring up menus to allow for rotation of the 3D model, weblinks to more information, or additional content such as describing how the 19th century locomotive 320 differs through innovation from the early locomotive 318, such as including a coal car for fuel, a light for nighttime operation, a steam operated whistle for alerting its upcoming presence or expected departure, multiple wheels for traction, a valve to allow refilling the water tank, a pilot or “cattle catcher” on the front to deflect obstacles on the track that might derail the train. The pilot also eliminated the need for fencing large stretches of train track. Accordingly, a much more enriched learning environment allows exploring more than just the technology of the steam engines but also how they affected and changed society from historical, economics, and technical perspectives, even with seeming simple innovations.

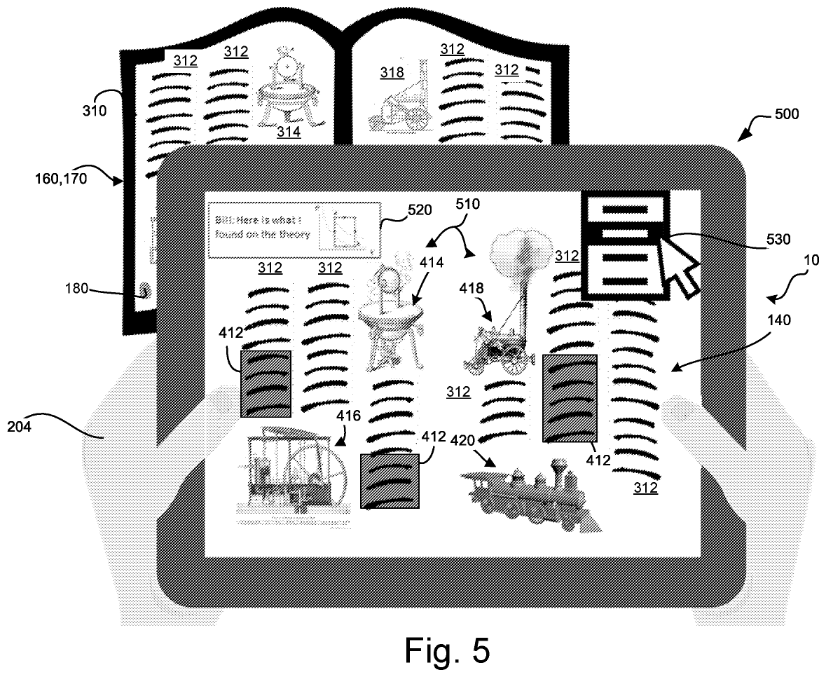

FIG. 5 is an illustration of an alternative example device 10, such as a tablet, with AR book viewer 140 used with the example physical book 160 or digital book 170 to view simulated augmented content 190. In this example, the camera of the tablet scans, captures, and identifies a set of one or more unique identifiers 180, including a page index. Each of the unique identifiers 180 identified and a set of orientation data for each marker for respective unique identifiers 180 is created. The set of unique identifiers 180, the instructor 202 identifiers, the learner 204 identifiers and a learner group identifier is sent to the API 124 in the database 122 to identify a set of augmented content for the page of learning material. The set of augmented content is based off the page identifier, the set of unique identifiers, the instructor identifier, the learner identifier, and the learner group identifier. Simulated augmented content 190 is generated by the AR book viewer 140 using the API 124 to retrieve augmented content 192 for the display of the tablet. The orientation of the simulated augmented content 190 may be determined by the AR book viewer 140 based on the set of augmented content 192 and at least one of the set of orientation data and the set of unique identifiers 180.

For example, textual content 312 is updated or enhanced with updated textual content 412 in one or more locations, three locations in this example. One or more pages 510 are enhanced by replacing the static pictures 314, 316, 318, and 320 with the AR content in 414, 416, 418, and 420, as described for FIG. 4, but now all as one inclusive simulated augmented content 190 due to the larger viewing area of the tablet. Note, however, that a smartphone-type electronic device 10 may also view the inclusive simulated augmented content 190 in full view, although perhaps at a slightly less readable size. Similarly, the tablet may display the various contents singly as with FIG. 4 or page-wide as in FIG. 5 as desired. By having the ability to view an entire page or more on the single screen at once, the learning experience becomes very immersive as the activity in each of the various updated content comes alive together at once. Further, because the location and position of the unique identifier(s) 190 are known, the learner 204 may orient the tablet with respect to the physical 160 or digital 170 book to view the enhanced pictures, movies, and particularly any 3D content from various orientations.

In addition, the simulated augmented content 190 may include an interactive menu 530 to allow the learner 204 to select various flows of material that the instructor 202 may provide. The interactive menu 530 may be available for the entire page and/or for each individual simulated augmented content 190. For instance, the instructor 202 may include a set of flows where one set provides a set of operating videos of the various steam engines. Another flow may display more detailed high resolution 2D images or 3D models of the particular steam engine types. Another flow may provide lists of links to various online content, such as museums, Wikipedia, encyclopedias, and reference books. Yet another flow may provide a view of additional content uploaded by fellow learners 204 that wish to share information that they have independently found or provided with their own particular insights. The simulated augmented content 190 may also include additional augmented content 520 such as a messaging system, video or voice conferencing system, and/or 2D or 3D audio/video/picture content to allow fellow learners 204 in a learner group to communicate with each other and share additional content directly without instructor 202 intervention. For instance, a group of learners 204 may begin a remote study session and share voice, video, images, and textual information while each are viewing the same page in the textbook 310.

Further description on how to implement and use the AR book viewer 140, the AR book creation tool 110, and the database 122 follows in the detailed discussion of the remaining Figures. The various examples described herein may include logic or several components, modules, or constituents. Modules may constitute either software modules, such as code embedded in tangible non-transitory machine or computer readable medium or hardware modules. A hardware module is a tangible unit capable of performing certain operations and by be configured or arranged in certain manners. In one example, one or more computer systems or one or more hardware modules of a computer system may be configured by software (e.g. an application, or portion of an application) as a hardware module that operates to perform certain operations as described herein.

In some examples, a hardware module may be implemented as electronically programmable. For instance, a hardware module may include dedicated circuitry or logic that is permanently configured (e.g. as a special-purpose processor, state machine, a field programmable gate array (FPGA) or an application specific integrated circuit (ASIC) to perform certain operations. A hardware module may also include programmable logic or circuity (e.g. as encompassed within a general-purpose processor or other programmable processor) that is temporarily configured by software to perform certain operations. A particular decision to implement a hardware module electronically in dedicated and permanently configured circuitry, or in temporarily configure circuitry (e.g. configured by software) may be driven by cost and time considerations.

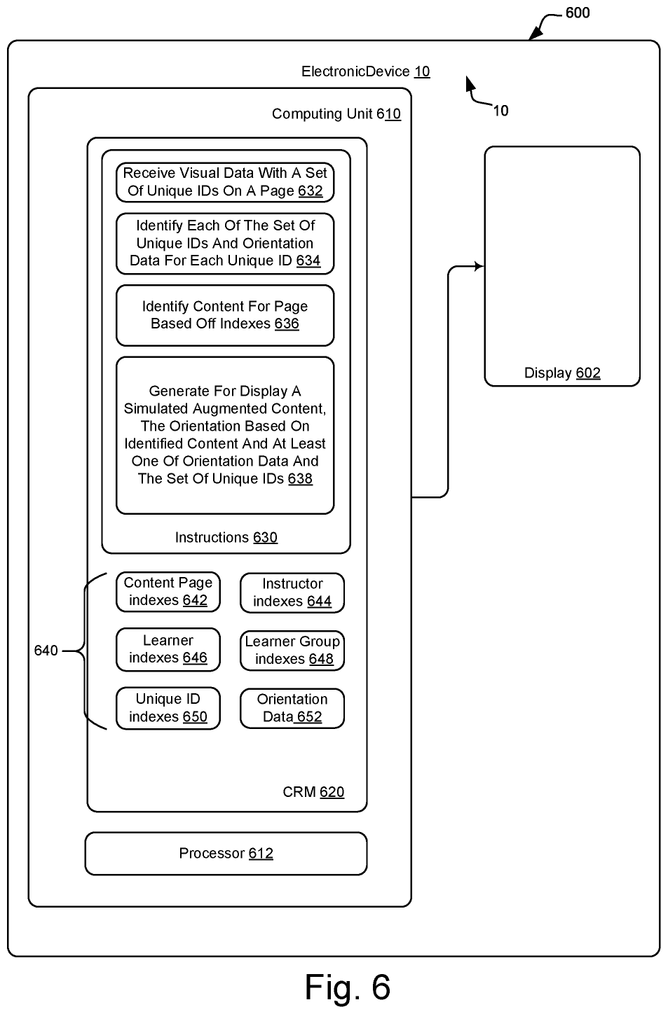

FIG. 6 is a block diagram 600 of an example electronic device 10 with AR book creation tool 140 to view simulated augmented content 190 by a learner 204. Electronic device 10 includes a computing unit 610 coupled to a display 602. Computing unit 610 includes a processor 612 and a tangible non-transitory computer readable medium (CRM) 620. CRM 620 allows for storage of one or more sets of data structures, such as a list of indexes 640 and instructions 630 (e.g. software, firmware, logic) embodying or utilized by any one or more of the methodologies or functions described herein. The instructions 630 may also reside, completely or at least partially, with the static memory, the main memory, and/or within the processor 612 during execution by the computing unit 610. The main memory and the processor memory may also constitute CRM 620. The term “computer readable medium” 620 may include single medium or multiple media (centralized or distributed) that store the one or more instructions 630 or data structures. The CRM 620 may be implemented to include, but not limited to, solid state, optical, and magnetic media whether volatile or non-volatile. Such examples include, semiconductor memory devices (e.g. Erasable Programmable Read-Only Memory (EPROM), Electrically Erasable Programmable Read-only Memory (EEPROM), and flash memory devices), magnetic discs such as internal hard drives and removable disks, magneto-optical disks, and CD-ROM (Compact Disc Read-Only Memory) and DVD (Digital Versatile Disc) disks.

Accordingly, electronic device 10 includes a non-transitory computer readable medium 620 including instructions 620 and a list containing a set of content page indexes 642, an instructor index 644, a learner index 646, and a learner group index 648. The indexes are created from the various identifiers as discussed in FIGS. 1-5. A processor 612 is configured to execute the instructions 630. The instructions 630 contain computer executable code in one or more modules, objects, or sub-routines as shown in blocks. In block 632, the code is to receive on the electronic device 10 visual data providing multiple images of a set of unique identifiers 180 on a page 230 of learning material associated with a content page index 642. In block 634, the code further is to create a set of unique identifier indexes 650 and a set of orientation data 652 for each unique identifier 180. The code in block 636 is then to identify a set of content 192 for the page of learning material wherein the set of content 192 is based off the content page index 642, the set of unique identifier indexes 650, the instructor index 644, the learner index 646, and the learner group index 648. In block 638, the code is to generate for display 602 on the electronic device 10 a simulated augmented content 190, the orientation of the simulated augmented content 190 is to be based on the set of content 192 and at least one of the set of orientation data 652 and the set of unique identifiers 650.

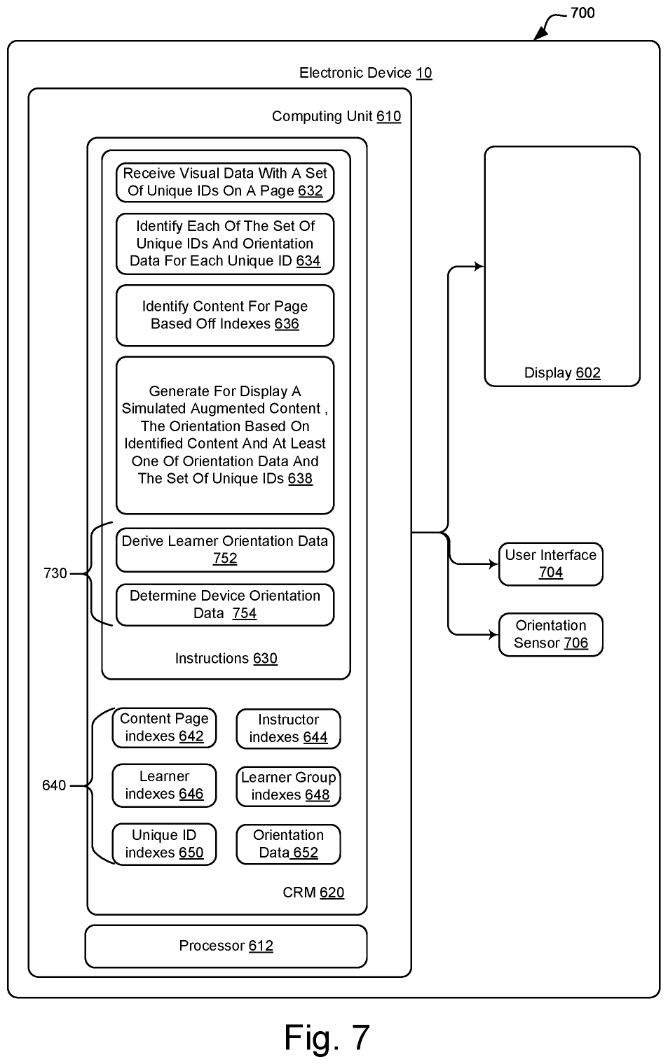

FIG. 7 is a block diagram 700 of an alternative example electronic device 10 to view simulated augmented content 190. Building from the block diagram 600 in FIG. 6, in this example, computing unit 610 is coupled to display 602, user interface 704, orientation sensor 706, and CRM 630. The user interface 704 allows for directional input from a learner 204, such as with a touch display, a pen-based display, keyboard input, mouse input, trackpad input, or touch point input and the like. The orientation sensor 706 may be a gyroscope, a set of accelerometers, mems or optically based sensors, or other type of device orientation sensor known to those of skill in the art. The instructions 630 contain additional instructions 730 to use the data from the user interface 704 and the orientation sensor 706.

In block 752, the additional instructions 730 are further to receive from the user interface 704 input from learner 204 and the additional instructions 730 are further to derive learner orientation data from the learner input. In block 754, the additional instructions 730 determine device orientation data of the device from the device orientation sensor 706. The simulated augmented content 190 displayed on the electronic device 10 is further oriented based on at least one of the learner orientation data and the device orientation data stored in orientation data records 652 on CRM 620.

In other example implementations, the electronic device 10 may be configured to where the simulated augmented content 190 includes an interactive user interface 530 (FIG. 5) to allow a learner 204 to choose amongst several different flows of simulated augmented content 190. Also, the instructions 630 may include further additional instructions to query a database 122 as shown in FIGS. 1 and 2. However, in some implementations, portions of the database 122 may be downloaded, cached, or pre-loaded onto electronic device 10 to reduce communication bandwidth during operation and to help speed up operation of the AR book viewer 140 application.

Also, some implementations may include instructions 630 to generate for display 602 and share additional augmented content 520 associated with the content page index 642 to and from other learners 204 associated with the learner group index 648. In the example of FIG. 5, a learner 204 named Bill shared that he found a thermo-dynamic graph of pressure vs volume for how steam engines work, thus providing additional content.

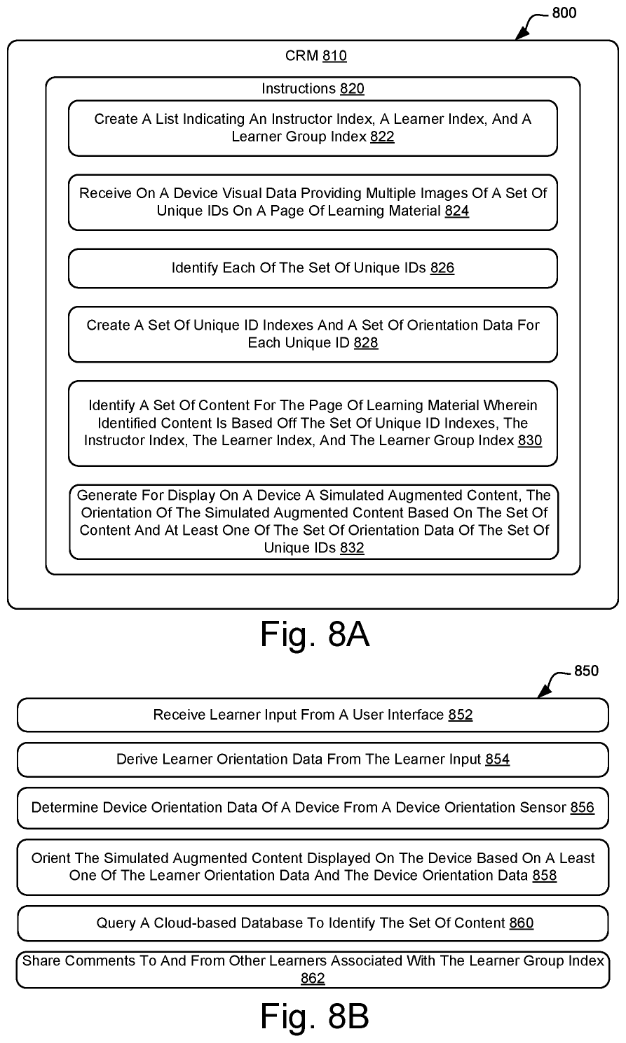

FIGS. 8A and 8B are a block diagram 800 of example modules of instructions 820 in a tangible non-transitory computer readable medium 810 to allow viewing of simulated augmented content 190 on various example electronic devices 10. The non-transitory computer readable medium 810 includes instructions 820 encoded thereon that when read and executed on a processor 612 cause the processor 612 to execute code in a set of software modules. For instance, in module 822 a list is created containing an instructor index 644, a learner index 646, and a learner group index 648. In module 824, visual data providing multiple images of a set of unique identifiers 180 on a page of learning material is received on an electronic device 10. In module 826, each of the set of unique identifiers is identified and in module 828, a set of unique identifier indexes 650 and a set of orientation data 652 is created for each unique identifier 180. In module 830, a set of content 192 for the page of learning material is identified wherein identified content is based off the set of unique identifier indexes 650, the instructor index 644, the learner index 646, and the learner group index 648. The set of content 192 may include an interactive user interface 530 to allow a learner 204 to choose amongst several different flows of simulated augmented content 190. In module 832, simulated augmented content 190 is generated for display on the electronic device 10 where the orientation of the simulated augmented content 190 is based on the set of content 192 and at least one of the set of orientation data 652 of the set of unique identifiers 180.

As shown in FIG. 8B, additional modules may be included as part of instructions 820. For instance, module 852 may provide code to receive learner input from a user interface 704. Module 854 may provide code to derive learner orientation data from the learner input in module 852. Device orientation data of an electronic device 10 may in module 856 be derived from a device orientation sensor 206. Accordingly, module 858 may provide code to orient the simulated augmented content 190 displayed on the electronic device 10 based on a least one of the learner orientation data and the device orientation data.

In module 860, the additional instructions 850 may allow the processor 612 to query a database 122 to identify the set of content 192. In some implementations, the additional instructions 850 in module 862 allow learners 204 within a learner group 206 to share comments to and from other learners 204 associated with the learner group index 648.

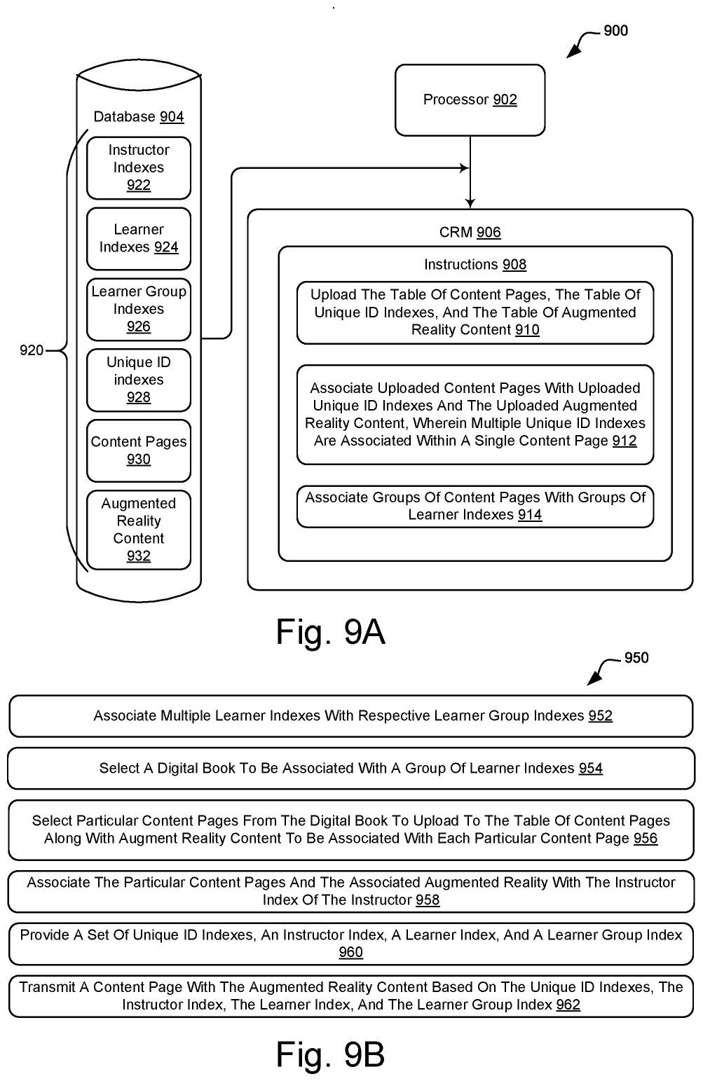

FIG. 9A is a block diagram of an example system 900, such as AR book creation tool 110 and database 122 in FIG. 1 for creating physical 160 or digital 170 books for viewing simulated augmented content 190. In the system 900, a processor 902 is coupled to tangible non-transitory computer readable medium (CRM) 906. CRM 906 includes instructions 908 in the form on one or more subroutines, modules, and/or objects of computer executable code. The processor 902 is further coupled to a database 904. The AR book creation tool 110 may be fully or partially implemented as part of a client-server system. In one example, the AR book tool 110 is a client application that may access the API interface 124 which may be part of system 900. In another example, the majority of the AR book creation tool 110 may be server-based and a thin-client may be run on a remote computer system to allow for the scanning, uploading, and association of electronic pages and augmented content.

The database 904 may be a database 122 (as in FIGS. 1 and 2) or it may be a local database present in system 900. The database 904 may contain multiple tables 920 of instructor indexes 922, learner indexes 924, learner group indexes 926, unique identifier indexes 928, content pages 930, and augmented reality content 932. Further, the database 904 may be distributed over one or more computer systems, some of which may be fully or partially part of system 900. Also, the database 904 may be partially cached or located within system 900 to reduce communication bandwidth and speed performance. The database 904 may include at least a table of instructor indexes 922 based from a unique identification (ID) of each instructor 202 and a table of learner indexes 924 based from a unique ID for each learner 204. Also, a table of learner group indexes 926 based off a unique ID for each learner group 206 may be provided to allow for assignment of classes, study groups, team projects, research circles, etc. Learners 204 may belong to one or more learner groups 206 and each learner 204 within a learner group 206 may share additional content amongst others within the respective learner group 206 and may include the instructor 202. A table of unique ID indexes 928 allow for individual identification of each page of content material as well as allowing for multiple unique identifiers 180 on a single page, such as when there are one or more illustrations, pictures, tables, etc. that an instructor 202 or learner 204 may wish to augment with supplemental augmented content.

The database 904 also includes a table of content pages 930 with the original material for each page along with indexes to instructors 202, learners 204, learner groups 206 and unique IDs 180 for respective pages. Further, a table of augmented reality content 932 includes a library of uploaded augmented reality content each of which are indexed to various pages in the set of content pages and may also include indexes for the instructors 202, learners 204, learner groups 206 and unique IDs 180.

Accordingly, the instructions 908 may contain multiple modules for executing computer readable code that when read and executed by the processor 902 allow the processor 902 to access a database 904 containing multiple tables of instructor indexes 922, learner indexes 924, learner group indexes 926, unique identifier indexes 928, content pages 930, and augmented reality content 932. A non-transitory computer readable medium 906 includes instructions 908 and the processor 902 to execute the instructions 908 in module 910 to allow an instructor 202 associated with indexes 920 in the table of instructor indexes 922 to upload to the table of content pages 930, to the table of unique identifier indexes 928, and to the table of augmented reality content 932. In module 912, the instructions 908 allow an instructor 202 to associate uploaded content pages 930 with uploaded unique identifier indexes 928 and the uploaded augmented reality content 932. The multiple unique identifiers indexes 928 are associated within a single content page 930. The instructor 202 may associate groups of content pages 930 with groups of learner indexes 926.

FIG. 9B is a block diagram of possible additional instructions 950 for the example system 900 of FIG. 9A. Accordingly, the system 900 may also include additional instructions 950 in module 952 to associate multiple learner indexes 924 with respective learner group indexes 926 so that the database 904 may include a table of learner comments (not shown) indexed by the learner group indexes 926. In modules 954 and 956, the additional instruction 950 may allow the instructor 202 when uploading to the table of content pages to select a digital book 170 to be associated with a group of learner indexes 926 and select particular content pages 930 from the digital book 170 to upload to the table of content pages 930 along with augment reality content 932 to be associated with each particular content page 930. The digital book 170 may include scanned pages of a physical book 160. Also, a module 958 may include code that when the instructor 202 uploads the table of content pages 930, the instructor 202 may associate the particular content pages 930 and the associated augmented reality content 932 with the instructor index 922 of the instructor 202.

In some implementations, the additional instruction 950 may contain modules 960 and 962 to allow a learner 204 associated with a learner index 926 to provide a set of unique identifier indexes 928, an instructor index 922, a learner index 924, and a learner group index 926 to the database 904. Further, the learner 204 may transmit a content page 930 with the augmented reality content 932 based on the unique identifier indexes 928, the instructor index 922, the learner index 924, and the learner group index 926 to the database 904 for sharing with other learners 204 in associated learner groups 206.

In summary, the disclosed subject matter recounts adding augmented reality (AR) to learning material whether in printed or electronic digital form. Markers or unique identifiers 180 in the form of invisible watermarks or picture recognition may be used to denote the additional AR content provided by an instructor 202 and that may be stored on a cloud-based or other type of implemented database 122. When the marker or unique identifier 180 is detected in the teaching materials by a learner 204 with an electronic device 10, the detected AR content is displayed as an augmented reality immersive experience. Unlike past augmented reality based learning systems, the disclosed subject matter allows for multiple markers per page of material, targeted material for individual learners 204, learner 204 sharing of notes, additional AR content, and communication with instructor 202 and other learners 204, which together form a learner group 206. Also, the instructor 202 may create multiple flows for different content and the ability to continually update the additional AR content.

While the claimed subject matter has been particularly shown and described with reference to the foregoing examples, those skilled in the art will understand that many variations may be made therein without departing from the intended scope of subject matter in the following claims. This description should be understood to include all novel and non-obvious combinations of elements described herein, and claims may be presented in this or a later application to any novel and non-obvious combination of these elements. The foregoing examples are illustrative, and no single feature or element is compulsory to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A device, comprising:
a non-transitory computer readable medium comprising instructions and a list containing a set of content page indexes, an instructor index, a learner index, and a learner group index;
a processor configured to execute the instructions to:
receive on a device visual data providing multiple images of a set of unique identifiers on a page of learning material associated with a page index;
create a set of unique identifier indexes and a set of orientation data for each unique identifier;
identify a set of content for the page of learning material wherein the set of content is based off the page index, the set of unique identifier indexes, the instructor index, the learner index, and the learner group index; and
generate for display on the device a simulated augmented content, the orientation of the simulated augmented content based on the set of content and at least one of the set of orientation data and the set of unique identifiers.

2. The device of claim 1, further comprising:
a user interface to receive learner input and the instructions are further to derive learner orientation data from the learner input;
a device orientation sensor and the instructions are further to determine device orientation data of the device from the device orientation sensor; and
wherein the simulated augmented content displayed on the device is further oriented based on at least one of the learner orientation data and the device orientation data.

3. The device of claim 1, wherein the simulated augmented content includes an interactive user interface to allow a learner to choose amongst several different flows of simulated augmented content.

4. The device of claim 1 wherein the instructions to identify the set of content include instructions to query a cloud-based database.

5. The device of claim 1 wherein the instructions to generate for display include instructions to share additional augmented content associated with the content page index to and from other learners associated with the learner group index.

6. A non-transitory computer readable medium having instructions encoded thereon that when read and executed on a processor cause the processors to:
create a list containing an instructor index, a learner index, and a learner group index;
receive on a device visual data providing multiple images of a set of unique identifiers on a page of learning material;
identify each of the set of unique identifiers;
create a set of unique identifier indexes and a set of orientation data for each unique identifier;
identify a set of content for the page of learning material wherein identified content is based off the set of unique identifier indexes, the instructor index, the learner index, and the learner group index; and
generate for display on a device a simulated augmented content, the orientation of the simulated augmented content based on the set of content and at least one of the set of orientation data of the set of unique identifiers.

7. The non-transitory computer readable medium of claim 6, further comprising instructions that cause the processor to:
receive learner input from a user interface;
derive learner orientation data from the learner input;
determine device orientation data of a device from a device orientation sensor; and
orient the simulated augmented content displayed on the device based on a least one of the learner orientation data and the device orientation data.

8. The non-transitory computer readable medium of claim 6, wherein the set of content includes an interactive user interface to allow a learner to choose amongst several different flows of simulated augmented content.

9. The non-transitory computer readable medium of claim 6, further comprising instructions that cause the processor to query a cloud-based database to identify the set of content.

10. The non-transitory computer readable medium of claim 6, further comprising instructions that cause the processor to share comments to and from other learners associated with the learner group index.

11. A system, comprising:
a database containing multiple tables of instructor indexes, learner indexes, learner group indexes, unique identifier indexes, content pages, and augmented reality content;
a non-transitory computer readable medium comprising instructions; and
a processor to execute the instructions to allow an instructor associated with indexes in the table of instructor indexes to:
upload to the table of content pages, to the table of unique identifier indexes, and to the table of augmented reality content;
associate uploaded content pages with uploaded unique identifier indexes and the uploaded augmented reality content, wherein multiple unique identifier indexes are associated within a single content page; and
associate groups of content pages with groups of learner indexes.

12. The system of claim 11, further comprising instructions to associate multiple learner indexes with respective learner group indexes, and wherein the database further comprises a table of learner comments indexed by the learner group indexes.

13. The system of claim 11, wherein the instructions to upload to the table of content pages further comprising instructions to:
select a digital book to be associated with a group of learner indexes; and
select particular content pages from the digital book to upload to the table of content pages along with augment reality content to be associated with each particular content page.

14. The system of claim 12, wherein the instructions to upload the table of content pages further comprise instructions to associate the particular content pages and the associated augmented reality content with the instructor index of the instructor.

15. The system of claim 11, wherein the memory comprising instructions include instructions to allow the processor to execute instructions to allow a learner associated with a learner index to:
provide a set of unique identifier indexes, an instructor index, a learner index, and a learner group index; and
transmit a content page with the augmented reality content based on the unique identifier indexes, the instructor index, the learner index, and the learner group index.
